(19) United States
(12) Patent Application Publication
(10) Pub. No.: US 2020/0283281 A1
(43) Pub. Date: Sep. 10, 2020

(54) BEVERAGE DISPENSING SYSTEM USING COMPRESSED AIR

(71) Applicant: The Coca-Cola Company, Atlanta, GA (US)

(72) Inventors: Jurgen ROEKENS, Kampenhout (BE); Joost DESSING, CN Hoofddorp (NL)

(21) Appl. No.: 16/491,914

(22) PCT Filed: Mar. 7, 2018
(86) PCT No.: PCT/US18/21261

§ 371 Date: Sep. 6, 2019

Related U.S. Application Data
(60) Provisional application No. 62/468,593, filed on Mar. 8, 2017.

(51) Int. Cl. B67D 1/04; B67D 1/08

(52) U.S. Cl. CPC B67D 1/0462; F25D 31/002; B67D 1/0857

(57) ABSTRACT

The present application provides a dispensing system for a beverage. The dispensing system may include a pressure chamber and a dispenser unit with a refrigeration compartment. The beverage may be stored within the pressure chamber and may be dispensed through the refrigeration compartment under pressure.

### TECHNICAL FIELD

The present application and the resultant patent relate generally to beverage dispensing system and more particularly relate to a beverage dispensing system using compressed air to drive a beverage fluid therethrough in a controlled and efficient manner.

### BACKGROUND OF THE INVENTION

Generally described, modern beverage dispensing systems may be relatively complex electromechanical devices. A typical beverage dispensing system may mix multiple ingredients to produce a beverage via a combination of pumps, valves, and other components as operated by an electronic controller and the like. Such complex electromechanical beverage dispensers, however, may not be suitable for use in all locations. For example, the size or cost of the beverage dispenser may not be practical for a given location, the location may lack reliable electric power, the location may lack potable water supplies, or the location may lack the infrastructure required to provide or store the different beverage ingredients. Other factors also may have an impact on the reliability of the beverage dispensing system and/or the quality of the beverages dispensed therefrom.

There is thus a desire for an improved beverage dispensing system that does not require complex electromechanical components to operate. Preferably, such a beverage dispensing system may provide premixed or otherwise ready to drink beverages in a low cost and efficient manner that maintains the quality of the beverage in terms of carbonation and the like over an extended period of time.

### SUMMARY OF THE INVENTION

The present application and the resultant patent thus provide a dispensing system for a beverage. The dispensing system may include a pressure chamber and a dispenser unit with a refrigeration compartment. The beverage may be stored within the pressure chamber and may be dispensed through the refrigeration compartment under pressure.

The present application and the resultant patent further provide a method of dispensing a beverage. The method may include the steps of storing the beverage in a pressure chamber, flowing the beverage under pressure from the pressure chamber to an ice bath, and dispensing the beverage under pressure from the ice bath.

The present application and the resultant patent further provide a dispensing system for a number of beverages. The dispensing system may include a number of pressure chambers, a compressed air source in communication with the number of pressure chambers, and a dispenser unit with an ice bath. The beverages may be stored within the pressure chambers and may be dispensed through the ice bath under pressure.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a perspective view of a beverage dispensing system as may be described herein.

FIG. 2 is an exploded view of a pressure chamber of the beverage dispensing system of FIG. 1.

FIG. 3 is a partial sectional view of a dispenser unit of the beverage dispensing system of FIG. 1.

FIG. 4 is a partial perspective view of a cooling coil for use with the dispenser unit of the beverage dispensing system of FIG. 1.

### DETAILED DESCRIPTION

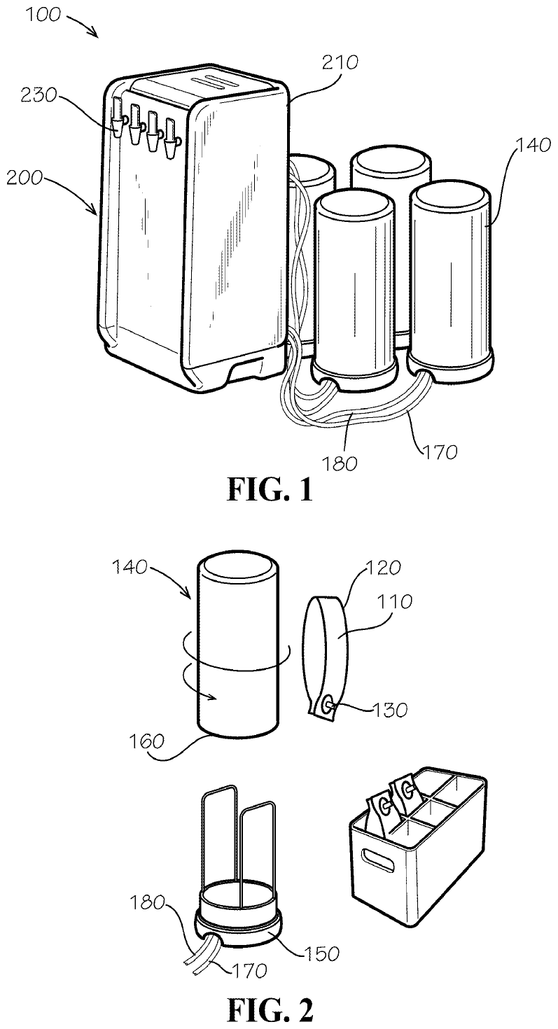

Referring now to the drawings, in which like numerals refer to like elements throughout the several views, FIG. 1 shows a beverage dispensing system 100 as may be described herein. The beverage dispensing system 100 may dispense a number of beverages 110 therein. The beverages 110 may include a number of premixed or otherwise ready to drink beverages. The beverages 110 may include waters, juices, carbonated soft drinks, sports drinks, coffees, teas, and the like. Any type of beverages 110 may be used herein.

The beverages 110 may be stored within a pouch 120. The pouch 120 may have any suitable size, shape, or configuration. The pouch 120 may be made out of a conventional thermoplastic or any type of food grade and flexible material. The pouch 120 may be similar to a conventional bag-in-box pouch and the like. The pouch 120 may include a spout 130 at one end thereof. The pouch 120 also may be of a type suitable for storing a carbonated pressurized beverage. Such a pouch 120 may have a glass fiber reinforced outer wall so as to withstand high internal pressures of, for example, greater than about five (5) bar. Other types of dispensing containers and dispensing elements also may be used herein.

As is shown in FIG. 2, the beverage dispensing system 100 may include one or more pressure chambers 140. Any number of the pressure chambers 140 may be used herein. The pressure chambers 140 may be sized to position and support one or more of the pouches 120 therein. The pressure chambers 140 may have any suitable size, shape, or configuration. Typically, the pressure chamber 140 may have at least some head space above the pouch 120. The head space generally causes a stable pressure level during a single dispense cycle and may eliminate the need for frequent pumping. The pressure chambers 140 may include a support base 150 and an outer shell 160. The support base 150 and the outer shell 160 may create a substantially airtight seal therebetween so as to allow the pressure chambers 140 to be pressurized to an elevated internal pressure. The support base 150 and the outer shell 160 may be made out of conventional thermoplastics or any substantially rigid material capable of withstanding an elevated pressure.

The beverage dispensing system 100 may include a product line 170 in communication the pouch 120 within the pressure chamber 140. Multiple product lines 170 may be used. The beverage dispensing system 100 also may include a pressure line 180. The pressure line 180 may be in communication with the outer shell 160 of the pressure chamber and a compressed air source 190. Multiple pressure lines 180 may be used. The compressed air source 190 may be of conventional design and may be either electrically or manually operated. The compressed air source 190 may be positioned within the beverage dispensing system 100 or remote therefrom. The compressed air source 190 may pressurize the outer shell 160 of the pressure chamber 140 with compressed air. Varying pressures may be used herein. Other components and other configurations may be used herein.

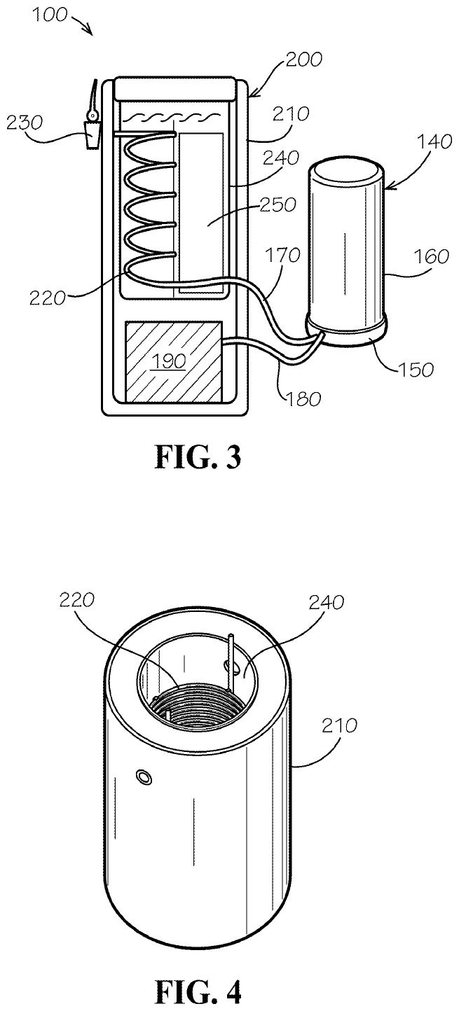

As is shown in FIGS. 3 and 4, the beverage dispensing system 100 may include a dispenser unit 200. The dispenser unit 200 may include an insulated shell 210. The insulated shell 210 may have any suitable size, shape, or configuration. The insulated shell 210 may be made out of any type of substantially rigid material with good insulating characteristics. One or more cooling coils 220 may be positioned within the insulated shell 210. The cooling coils 220 may be of conventional design and may be made from any type of substantially rigid materials with good heat exchange characteristics. The cooling coils 220 may extend from the product lines 170 to a number of taps 230. The taps 230 may be of conventional design and may be any type of open or shut dispensing device.

The insulated shell 210 and the cooling coils 220 may define a refrigeration compartment. In this example, the refrigeration compartment may be an ice bath 240. The ice bath 240 may have any suitable size, shape, or configuration. An amount of ice/water 250 may be positioned within the ice bath 240 so as to chill the beverage 110 within the coiling coils 220. The taps 230 may be positioned about the top of the ice bath 240 such that the outgoing beverage 110 may be at about zero degrees Celsius (0° C.) while the incoming beverage may be at about 4 degrees Celsius (4° C.) (as a result of the density of water in function of its temperature). This passage also may instigate water currents within the ice bath 240 without the use of an agitator. Other types of refrigeration may be used herein. For example, a conventional electric powered refrigeration device may be used given a stable power supply. Other components and other configurations may be used herein.

In use, one or more of the pouches 120 may be positioned within one of the pressure chambers 140. The pouch 120 may be attached to the product line 170. The outer shell 150 may be securely attached to the support base 150. The pressure chamber 140 may be pressurized by the compressed air source 190 via the pressure line 180. The compressed air creates a uniform pressure on the pouch 120 and the beverage 110 therein so as to cause the beverage 110 to flow to the dispenser unit 200. Specifically, the beverage 110 may flow from the product lines 180, through the cooling coils 220, to the taps 230. An amount of the ice/water 250 may be placed in the ice bath 240. The ice bath 240 cools the beverage 110 in the cooling coils 220.

Opening one of the taps 230 causes the pressurized beverage 110 to flow therethrough. Specifically, the compressed air in the pressure chamber 140 causes the beverage 110 to flow through the dispenser unit 200. The ice/water 250 may be replaced on a predetermined schedule to keep the beverage 110 therein at a sufficiently chilled temperature. The pouches 120 and the compressed air source 190 may be replaced as needed. The beverage dispensing system 100 may be cleaned and sanitized in a conventional manner. Although the pressure chambers 140 and the dispenser unit 200 are shown as separate components, all or some of the components of the beverage dispensing system 100 may be positioned within a common housing and the like.

The beverage dispensing system 100 described herein thus provides efficient dispensing of beverages 110 without the use of electro-mechanical parts or even the use of electricity. The beverage dispensing system 100 allows the use of conventional pouches 120 with a ready to drink beverage 110 therein instead of relying on the multiple ingredients usually required in conventional dispensers. The beverage dispensing system 100 thus may be used in almost any location without regard to local conditions. Moreover, the beverage dispensing system 100 may avoid the initial capital expenditures usually associated with premixed beverages, i.e., typically requiring numerous five gallon containers and the like. As such, the beverages 110 may be offered at a lower price point given the reduced cost of packaging.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof

We claim:

1. A dispensing system for a beverage, comprising:
a pressure chamber; and
a dispenser unit;
the dispenser unit comprising a refrigeration compartment;
wherein the beverage is stored within the pressure chamber and is dispensed through the refrigeration compartment under pressure.

2. The dispensing system of claim 1, wherein the pressure chamber comprises a pouch and wherein the beverage is within the pouch.

3. The dispensing system of claim 1, wherein the pressure chamber comprises a base and a shell.

4. The dispensing system of claim 1, wherein the pressure chamber comprises a plurality of pressure chambers.

5. The dispensing system of claim 1, wherein the pressure chamber comprises a compressed air source in communication therewith.

6. The dispensing system of claim 5, wherein the compressed air source is positioned within the dispenser unit.

7. The dispensing system of claim 5, wherein the compressed air source is in communication with the pressure chamber via a pressure line.

8. The dispensing system of claim 1, wherein the refrigeration compartment comprises an ice bath.

9. The dispensing system of claim 8, wherein the dispenser unit comprises a plurality of cooling coils positioned within the ice bath.

10. The dispensing system of claim 9, wherein the plurality of cooling coils is in communication with the beverage via a product line.

11. The dispensing system of claim 9, wherein the plurality of cooling coils is in communication with a tap.

12. The dispensing system of claim 1, wherein the dispenser unit comprises an insulated shell.

13. The dispensing system of claim 1, wherein the beverage comprises a premixed beverage.

14. The dispensing system of claim 1, wherein the beverage comprises a plurality of beverages.

15. A method of dispensing a beverage, comprising:
storing the beverage in a pressure chamber;
flowing the beverage under pressure from the pressure chamber to an ice bath; and
dispensing the beverage under pressure from the ice bath.
